(19) United States
(12) Patent Application Publication
(10) Pub. No.: US 2021/0231821 A1
(43) Pub. Date: Jul. 29, 2021

(54) APPARATUS FOR SIMULTANEOUS LOGGING FOR MULTIPOLE SONIC AND ACOUSTIC REFLECTION SURVEY

(71) Applicant: Schlumberger Technology Corporation, Sugar Land, TX (US)

(72) Inventors: Toshihiro Kinoshita, Sugar Land, TX (US); Hiroshi Nakajima, Sugar Land, TX (US); Takeshi Endo, Sugar Land, TX (US); Yuichi Kobayashi, Sugar Land, TX (US); Takeshi Fukushima, Sugar Land, TX (US)

(21) Appl. No.: 16/775,045

(22) Filed: Jan. 28, 2020

(51) Int. Cl. G01V 1/46; G01V 1/24; G01V 1/52; E21B 49/00

(52) U.S. Cl. CPC G01V 1/46; G01V 1/247; G01V 1/523; G01V 2210/1429; G01V 2210/121; G01V 2210/1299; E21B 49/00

(57) ABSTRACT

An apparatus for simultaneous logging presenting a capability to perform multipole sonic and acoustic reflection surveys for near-borehole and far field imaging.

### CROSS-REFERENCE TO RELATED APPLICATIONS

None.

### FIELD OF THE DISCLOSURE

Aspects of the disclosure relate to recovery of hydrocarbons from strata. More specifically, aspects of the disclosure relate to apparatus and methods for sonic logging in horizontal and highly deviated wells.

### BACKGROUND

As hydrocarbon assets decrease around the world, the use of unconventional reservoirs has started to flourish. Unconventional reservoirs are becoming increasingly important sources of energy in the United States as vast amounts of shale hold large amounts of hydrocarbons waiting to be tapped. The interest in shale gas and oil is also spreading to many other areas around the world such as Eastern Europe.

Shale gas and oil production relies on two techniques to increase wellbore exposure to the hydrocarbon bearing formation, horizontal drilling and hydraulic fracturing. These drilling techniques make it more challenging for conventional wireline sonic logging tools to characterize such formations. Generally, compressional values from a cross dipole sonic logging tool can provide useful information to evaluate the presence of anisotropic strata, thus indicating where hydrocarbons may be stored. When properly analyzed, this information enables an efficient planning, drilling and recovery of stored hydrocarbons. At solid-fluid interfaces, certain types of waves, called Stoneley waves, can propagate. Analysis of these Stoneley waves can give drillers and researchers a tool upon which an estimation of fractures and formation permeability can be estimated. In vertical seismic profiles, however, Stoneley waves are a major source of noise.

Application of the transmission of Stoneley waves can aid in several different drilling areas, including well placement, wellbore stability, and completion optimization to production optimization. Although it is well-known that cross dipole sonic and Stoneley logging provides useful value in hydrocarbon exploration and production, logging is carried out in a very limited number of horizontal wells or high angle wells due to the problems with vertical profiles.

Two different problems are encountered by sonic logging tools. A first problem is that the logging tool is required to be sufficiently structurally robust for use in severe environments. The structural rigidity is important for ensuring good centralization of the logging tool in a horizontal well which is more prominent with the use of unconventional sources. If the tool is not properly located in a borehole, dipole measurement is easily contaminated with Stoneley mode waves, described above. The second problem is that the logging tool should be sufficiently flexible so that the tool has an intrinsic flexural mode that is slower than the borehole flexural mode. If the tool intrinsic flexural mode is not sufficiently slow, the borehole flexural and the tool flexural modes interfere with each other, and the borehole flexural mode which is to be measured, is altered.

There is a need to provide sonic apparatus and methods that are easier to operate than conventional sonic apparatus and methods.

There is a further need to provide apparatus and methods that do not have the drawbacks discussed above related to conventional sonic apparatus.

There is a still further need to reduce economic costs associated with operations and apparatus described above with conventional sonic tools, wherein the operations and apparatus are not prone to error when used in horizontal or highly deviated wells.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept. Aspects of the disclosure relate to acoustic reflection surveys for near-borehole and far field imaging.

In one example embodiment, an acoustic apparatus is described. The apparatus may comprise an acoustic source section, at least two acoustic receiver sections, an isolator section arranged between the acoustic source section and the at least two acoustic receiver sections, wherein the isolator section is configured to function acoustically as a tuned mechanical band-stop filter. The apparatus may also be configured wherein each acoustic receiver section has at least one sensor, at least one amplifier, an analog-to-digital converter and multiplexer in one module.

In another embodiment, an acoustic apparatus is disclosed. The acoustic apparatus may comprise an acoustic source section, at least one acoustic receiver section, and an isolator section arranged between the acoustic source section and the acoustic receiver section, wherein the isolator section is configured to function acoustically as a tuned mechanical band-stop filter, and wherein the isolator section is configured to mute sonic signal propagation along the apparatus for which formation signals are considered to be dominant. The apparatus may also be configured to wherein each acoustic receiver section comprises: a transducer element configured to detect acoustic signals; an electronic circuit configured to process the acoustic signals, the electronic circuit including an amplifier, and an analog-to-digital converter; and a digital multiplexer. The acoustic receiver section may also comprise a fluid container configured to house the transducer element and the electronic circuit, and wherein the sensors, the amplifier and the analog-to-digital converter are placed in an individual module, and the electronic circuit is configured to simultaneously conduct monopole and dipole sonic logging and acoustic reflection surveys for near-borehole and far field imaging.

In another embodiment, an acoustic apparatus is disclosed. The apparatus may comprise an acoustic source section, an acoustic receiver section, and an isolator section arranged between the acoustic source section and the acoustic receiver section, wherein the isolator section is configured to function acoustically as a tuned mechanical band-stop filter, and wherein the isolator section is configured to mute sonic signal propagation along the apparatus for which formation signals are considered to be dominant. Each acoustic receiver section may comprise a transducer element configured to detect acoustic signals, an electronic circuit configured to process the acoustic signals, the electronic circuit including an amplifier, an analog-to-digital converter and a digital multiplexer. The acoustic apparatus may further comprise a fluid container configured to house the transducer element and the electronic circuit. The acoustic apparatus may also be configured wherein the sensors, the amplifier, and the analog-to-digital converter are placed in an individual module; and wherein the acoustic apparatus is configured to be one of attached to a drill string and placed on a wireline and the electronic circuit is configured to simultaneously conduct monopole and dipole sonic logging and acoustic reflection surveys.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted, however, that the appended drawings illustrate only typical embodiments of this disclosure and are therefore not be considered limiting of its scope, for the disclosure may admit to other equally effective embodiments.

FIG. 1 is a drill rig performing a hydrocarbon highly deviated recovery operation producing a horizontal wellbore in which one aspect of the disclosure will be used.

FIG. 2 is a side view of the apparatus for simultaneously logging for multipole sonic and acoustic reflection surveys.

FIG. 3 is a flow diagram for data processing for the apparatus for simultaneous logging for multipole sonic and acoustic reflection surveys.

FIG. 4 is a first receiver configuration for use in the apparatus for simultaneously logging presented in FIG. 2.

FIG. 5 is a second receiver configuration for use in the apparatus for simultaneously logging presented in FIG. 2.

FIG. 6 is a view of the internal frame and associated components of the second receiver configuration of FIG. 5.

FIG. 7 is a view of a mass-spring assembly.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and shall not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

Aspects of the disclosure relate to an apparatus and method for simultaneous logging for multipole sonic sources to perform an acoustic reflection survey. Aspects of the disclosure are particularly important in horizontal and highly deviated wellbores that conventional apparatus have difficulty evaluating. Certain components within the apparatus are strategically located such that a minimum of space is provided so that the apparatus can be reduced in size. Reducing such spacing and overall size allows the apparatus to be used in curving boreholes where length is a limiting factor with conventional apparatus and methods. By being able to conduct two types of logging at one time, the apparatus discussed provides economic advantages for deviated wells not previously achievable.

First, the aspect of drilling a deviated wellbore is described to allow the reader to understand the basics of wellbore production. After wellbore production, the use of an apparatus, in different aspects and configurations, will be discussed. As will be described, aspects of the apparatus described may be used on wireline apparatus after a well is drilled or may be fed through a drill string and through openings in the drill bit, providing a through bit capability previously not achieved.

Vertical and horizontal wellbores are drilled into a formation or formations that contain a desirable fluid, such as oil or gas. These wellbores may be fluid-filled wellbores (e.g. filled with the drilling fluid). In order to perform an analysis of the surrounding formation, the wellbore can have a sonic logging tool deployed therein. The sonic logging apparatus can be a wireline logging tool, for example. Although wireline logging tools are provided as examples herein, it should be understood that the sonic logging apparatus can also be measure while drilling tool. The sonic logging apparatus can include one or more acoustic sources and one or more acoustic receivers arranged therein. Example embodiments of a sonic logging apparatus is described in further detail below.

Aspects of the apparatus may determine different parameters of the geological stratum, including shear slowness, Poisson's ratio, compressional slowness. Other parameters may also be derived from such analysis, such as Stoneley slowness, and hydrocarbon detection. Other interpretation techniques can also be used on the data obtained by the apparatus described below, including fast shear slowness, slow shear slowness, maximum stress orientation, Stoneley mobility and Stoneley fracture analysis.

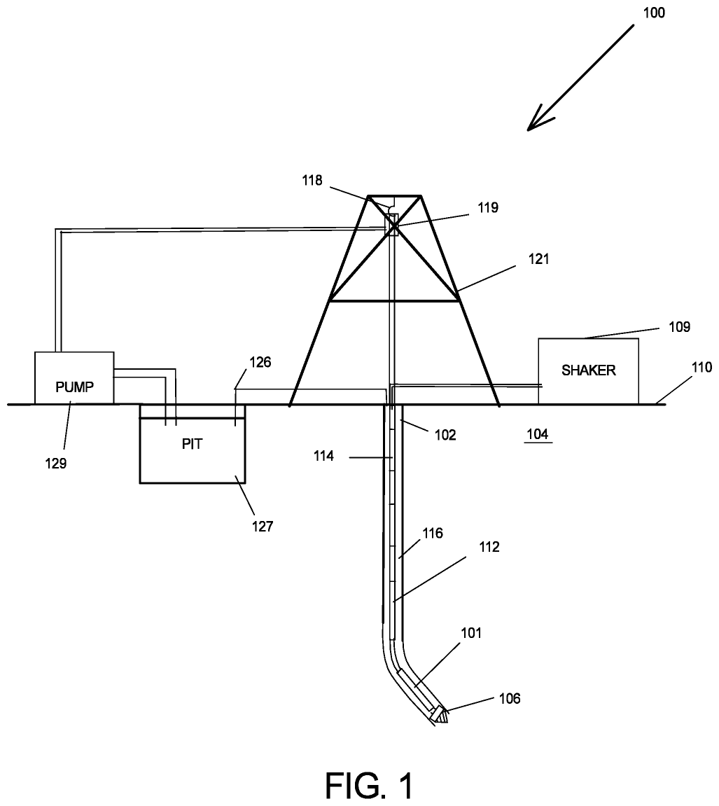

Referring to FIG. 1, a drilling rig 101 is illustrated. The purpose of the drilling rig 101 is to recover hydrocarbons located beneath the surface 110. Different stratum 104 may be encountered during the creation of a wellbore 102. In FIG. 1, a single stratum 104 layer is provided. As will be understood, multiple layers of stratum 104 may be encountered. In embodiments, the stratum 104 may be horizontal layers. In other embodiments, the stratum 104 may be vertically configured. In still further embodiments, the stratum 104 may have both horizontal and vertical layers. Stratum 104 beneath the surface 110 may be varied in composition, and may include sand, clay, silt, rock and/or combinations of these. Operators, therefore, need to assess the composition of the stratum 104 in order to maximize penetration of a drill bit 106 that will be used in the drilling process. The wellbore 102 is formed within the stratum 104 by a drill bit 106. In embodiments, the drill bit 106 is rotated such that contact between the drill bit 106 and the stratum 104 causes portions (“cuttings”) of the stratum 104 to be loosened at the bottom of the wellbore 102. Differing types of drill bits 106 may be used to penetrate different types of stratum 104. The types of stratum 104 encountered, therefore, is an important characteristic for operators. The types of drill bits 106 may vary widely. In some embodiments, polycrystalline diamond compact (“PDC”) drill bits may be used. In other embodiments, roller cone bits, diamond impregnated or hammer bits may be used. In embodiments, during the drilling process, vibration may be placed upon the drill bit 106 to aid in the breaking of stratum 104 that are encountered by the drill bit 106. Such vibration may increase the overall rate of penetration (“ROP”), increasing the efficiency of the drilling operations.

As the wellbore 102 penetrates further into the stratum 104, operators may add portions of drill string pipe 114 to form a drill string 112. As illustrated in FIG. 1, the drill string 112 may extend into the stratum 104 in a vertical orientation. In other embodiments, the drill string 112 and the wellbore 102 may deviate from a vertical orientation. In some embodiments, the wellbore 102 may be drilled in certain sections in a horizontal direction, parallel with the surface 110.

The drill bit 106 is larger in diameter than the drill string 112 such that when the drill bit 106 produces the hole for the wellbore 102, an annular space is created between the drill string 112 and the inside face of the wellbore 102. This annular space provides a pathway for removal of cuttings from the wellbore 102. Drilling fluids include water and specialty chemicals to aid in the formation of the wellbore 102. Other additives, such as defoamers, corrosion inhibitors, alkalinity control, bactericides, emulsifiers, wetting agents, filtration reducers, flocculants, foaming agents, lubricants, pipe-freeing agents, scale inhibitors, scavengers, surfactants, temperature stabilizers, scale inhibitors, thinners, dispersants, tracers, viscosifiers, and wetting agents may be added.

The drilling fluids may be stored in a pit 127 located at the drill site. The pit 127 may have a liner to prevent the drilling fluids from entering surface groundwater and/or contacting surface soils. In other embodiments, the drilling fluids may be stored in a tank alleviating the need for a pit 127. The pit 127 may have a recirculation line 126 that connects the pit 127 to a shaker 109 that is configured to process the drilling fluid after progressing from the downhole environment.

Drilling fluid from the pit 127 is pumped by a mud pump 129 that is connected to a swivel 119. The drill string 112 is suspended by a drive 118 from a derrick 121. In the illustrated embodiment, the drive 118 may be a unit that sits atop the drill string 112 and is known in the industry as a “top drive”. The top drive is configured to provide the rotational motion of the drill string 112 and attached drill bit 106. Although the drill string 112 is illustrated as being rotated by a top drive, other configurations are possible. A rotary drive located at or near the surface 110 may be used by operators to provide the rotational force. Power for the rotary drive or the top drive may be provided by diesel generators.

Drilling fluid is provided to the drill string 112 through a swivel 119 suspended by the derrick 121. The drilling fluid exits the drill string 112 at the drill bit 106 and has several functions in the drilling process. The drilling fluid is used to cool the drill bit 106 and remove the cuttings generated by the drill bit 106. The drilling fluid with the loosened cuttings enter the annular area outside of the drill string 112 and travel up the wellbore 102 to a shaker 109. The drilling fluid provides further information on the stratum 104 being encountered and may be tested with a viscometer, for example, to determine formation properties. Such formation properties allow engineers the ability to determine if drilling should proceed or terminate.

The shaker 109 is configured to separate the cuttings from the drilling fluid. The cuttings, after separation, may be analyzed by operators to determine if the stratum 104 currently being penetrated has hydrocarbons stored within the stratum 104 level that is currently being penetrated by the drill bit 106. The drilling fluid is then recirculated to the pit 127 through the recirculation line 126. The shaker 109 separates the cuttings from the drilling fluid by providing an acceleration of the fluid on to a screening surface. As will be understood, the shaker 109 may provide a linear or cylindrical acceleration for the materials being processed through the shaker 109. In embodiments, the shaker 109 may be configured with one running speed. In other embodiments, the shaker 109 may be configured with multiple operating speeds. In embodiments, the shaker 109 may operate at multiple operating speeds. The shaker 109 may be configured with a low speed setting of 6.5 “g” and a high speed setting of 7.5 “g”, where “g” is defined as the acceleration of gravity. Large cuttings are trapped on the screens, while the drilling fluid passes through the screens and is captured for reuse. Tests may be taken of the drilling fluid after passing through the shaker 109 to determine if the drilling fluid is adequate to reuse. Viscometers may be used to perform such testing.

As will be understood, smaller cuttings may pass entirely through the screens of the shaker 109 such that the fluids may include many smaller size cuttings. The overall quality of the drilling fluid, therefore, may be compromised by such smaller cuttings. The drilling fluid may be, as example, water based, oil based or synthetic based types of fluids. The fluid provide several functions, such as the capability to suspend and release cutting in the fluid flow, the control of formation pressures (pressures downhole), maintain wellbore 102 stability, minimize formation damage, cool, lubricate and support the bit 106 and drilling assembly, transmission of energy to tools and the bit 106, control corrosion and facilitate completion of the wellbore 102. In embodiments, the drilling fluid may also minimize environmental impact of the well construction process.

Aspects of the disclosure relate to an apparatus for conducting monopole and dipole sonic logging as well as acoustic reflection surveys simultaneously in a fluid filled borehole. Aspects of the disclosure may be used in horizontal wellbores 102, as illustrated in FIG. 1. The disclosure is also applicable for highly deviated or high angle wells. As will be understood, high angle wells have specific geometries that prevent conventional apparatus from being used in the wellbore 102. These wellbores 102 have an angular radius that prevents long sonic tools from being used as the sonic tools will get stuck in the angular radius when the wellbore curves. By way of description, a fluid filled wellbore 102 may be a wellbore 102 filled with drilling fluid, wherein the drilling fluid is used to carry cuttings to the surface, as described in FIG. 1.

In one aspect of the disclosure, sensors, analog-to-digital converters and digital multiplexers are encapsulated into an individual module not accomplished in conventional apparatus. This apparatus is then attached to a wireline, for example, for placement into the wellbore 102. In other embodiments, the apparatus may be connected to a drill string 112. In embodiments, two or more receiver modules may also be arranged within the body of the apparatus. The configuration of the apparatus may be such that the receiver modules are located near an outer diameter of the module to allow for measurement of pressure differences for dipole measurements. Each individual receiver module may be capable of high-quality measurement by digitizing the signal near the sensor location, thereby providing a higher quality result.

Aspects of the disclosure allow for high-quality dipole sonic measurements in a small diameter logging tool that is applicable for deviated wells so that the apparatus may pass through curves in the wellbore 102. In embodiments, extensional and flexural modes intrinsic to the logging tool itself are sufficiently muted or delayed. Thus, different size tools may be chosen for the anticipated geological conditions and wellbore 102 conditions that are expected. By matter of example, flexural modes that are close to anticipated received acoustic signals may be avoided by having different size or shaped tools, thereby enhancing data received.

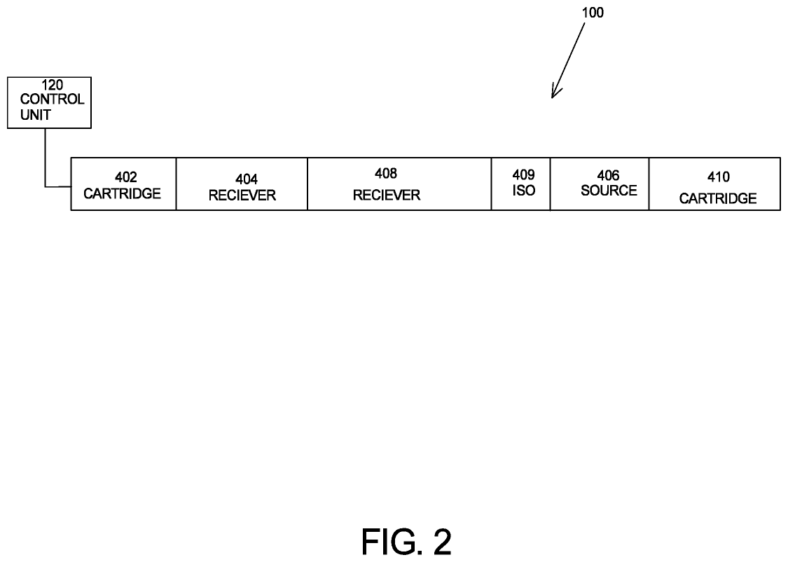

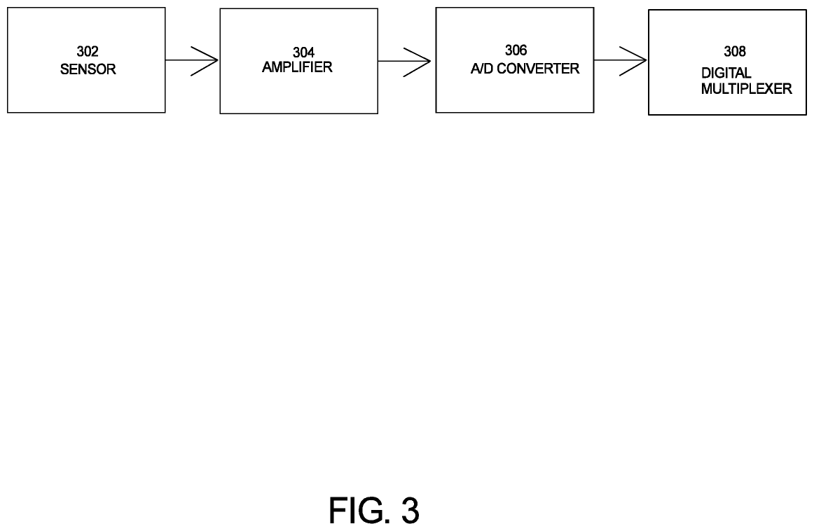

Referring to FIG. 2, an overall configuration of the apparatus 100 is illustrated. The apparatus 100 comprises two cartridges 402, 410, a source 406 and two receivers 404, 408. The purpose of the source 406 is to generate sonic energy which is transmitted to strata 104 around the wellbore 102. The purpose of the receivers 404, 408 is to provide for discrete points at which the sonic energy produced by the source 406 is received. The purpose of the electronic cartridges 402, 410 is to include circuitry for data acquisition, data storing, signal processing and communication with other devices and tools both downhole and uphole. As will be understood, the receivers 404, 408 amplifiers 304 (see FIG. 3), analog-to-digital converters 306 (see FIG. 3) and digital multiplexer 308 (see FIG. 3) may be placed in an individual portion of the apparatus 100. A control unit 120 is also provided to control different portions of the apparatus 100 as later described.

In embodiments, referring to FIG. 3, high quality measurements may be accomplished by a small-diameter apparatus. FIG. 3 illustrates a flow diagram of data proceeding along the apparatus for processing for the acoustic receiver 404, 408. The acoustic receiver 404, 408, in one non-limiting embodiment, includes an amplifier 304, at least one sensor 302, an analog-to-digital converter 306, and digital multiplexer 308. As described previously, these components may be located with the receiver 404, 408 to reduce space in the apparatus 100. Data is received at a receiver module 404, 408 after generation by source 406. The energy that is bounced off the geological stratum 104 is received at the receivers 404, 408. As the received energy may be very weak, the data from the receivers 404, 408 may be amplified through the amplifier 304 either prior to analog-to-digital conversion by the converter 306. Multiplexing may then occur by the multiplexer 308.

In embodiments, the sensor 302 may include specific components. These components may include a hydrophone or accelerometer that may be used to detect a wave or series of waves, for example, according to certain implementations. The amplifier 304 is configured to amplify the signal received by the sensor 302. The amplifier 304 may also be configured with filtering mechanisms or filtering logic to filter the received signal. Such filtering may also provide better signal to noise ratios, as necessary.

An analog-to-digital converter 306 is also positioned within the acoustic receiver 404, 408 to digitize the signal, as provided from the amplifier 304. As stated previously, the signal generated by the amplifier 304 may be a filtered signal, if desired. The signal generated by the analog-to-digital converter 306 may then pass to a digital multiplexer 308. The purpose of the digital multiplexer 308 is to allow data communication capability to either one or both of the electronics cartridges inside the apparatus 100. The use of the digital multiplexer 308 reduces the number of cables within the apparatus 100 so that communications may be made without signal degradation. Moreover, the reduction of the number of cables allows for a slimmer profile of the apparatus 100 and a reduced number of mechanical connections within the apparatus 100, resulting in a more robust apparatus 100 to environmental conditions.

In one example embodiment, the at least one sensor 302, amplifier 304, analog-to-digital converter 306 and digital multiplexer 308 are contained in a single unit. This unit may be closely positioned to both a control unit 120 and cartridges 402, 410 to allow for a very slim apparatus, quick response and more environmentally robust apparatus 100. The close proximity of the equipment allows data obtained by the sensor 302 to be digitized without sending analog signals over an extensive network of cables for communication with the electronics cartridge.

The acoustic receiver 404, 408 may be mounted as an outermost component. A fluid container is also positioned such that the acoustic receiver 404, 408 is positioned to be able to effectively receive signals transmitted by the source 406. Having fluid in the module provides fluid volume compensation so the pressure inside and outside the acoustic receiver 404, 408 allows the apparatus 100 to have a balance under the downhole environment. As the fluid in the container directly contacts the electronics inside, embodiments disclosed herein provide a fluid that is electronically nonconductive. The type of nonconductive fluid that may be used is silicone oil.

The apparatus 100 may be operably connected with the control unit 120. The positioning of the control unit 120 may vary with different configurations. In one embodiment, the control unit 120 may be located above the surface of the formation. In another embodiment, the control unit 120 may be located below the surface of the formation. In a still further embodiment, the control unit 120 may be located at the surface 110 of the formation. In other configurations, the control unit 120 can be integrated with the acoustic apparatus 100 and arranged in the wellbore 102. In embodiments, the control unit 120 may also be configured to control the acoustic source 406 within the apparatus 100 as well as providing for the receiving, processing and storing of data.

In one configuration, the control unit 120 may include at least one data processing unit and system memory. The type of system memory that is used may vary according to different configurations. In one embodiment, a random access memory (“RAM”) may be used. In another example embodiment, a read only memory (“ROM”) may be used. In still further embodiments, a combination of RAM and ROM may also be used. The processing unit can be standard programmable processor that performs arithmetic and logical operations for operation of the control unit 120.

The processing unit may be configured to execute program code as provided by a system memory and/or tangible computer readable media. Computer readable media refers to any media that is capable of providing data that cause the control unit 120 to operate in a desired manner. Different types of computer readable media may be used and as such, a non-limiting example list of media may be used. Media that may be used include an integrated circuit, a hard disk, and optical disc, a floppy disk, a magnetic tape, a holographic storage medium, CD-ROM, or digital versatile disks as nonlimiting embodiments.

In addition, the control unit 120 can have additional features/functionality. For example, the control unit 120 may include additional storage such as removal storage and nonremovable storage including, but not limited to, magnetic or optical discs or tapes. The control unit 120 may also be configured to operate in conjunction with computer networks that may be used at the wellsite. The control unit 120 may be pre-configured with network connections to allow the apparatus 100 to communicate with other devices and/or the network. The control unit 120 may also have input devices such as a keyboard, mouse, touchscreen, etc. or connections that allow for connection of such devices. Such connections may include universal serial bus connections. Output devices or output ports may also be included with the configuration of the control unit 120. Such output devices may include a display, speakers, printer, etc., may also be included.

The electronic cartridges 402, 410 may also be configured with circuitry and or power sources for controlling the acoustic sources in the acoustic source 406 as well as the acoustic receivers 404, 408 in the acoustic receiver section respectively. Thus, the electronic cartridges 402, 410 may work in conjunction with the control unit 120 so that actuation of the source is accomplished and the receivers 404, 408 are active and waiting for an echo return of acoustic energy.

An isolator section 409 may be located in a position between the acoustic source section 406 and the acoustic receiver sections 404, 408. The length of the isolator section 409 may be selected based on parameters to be measured. The length of the isolator section 409 may be based on frequency bands that would aid in the acquisition of transmitted signal from the source 406, wherein muting in a certain frequency band is desired. Thus, the apparatus 100 may be designed such that the formation signals can be in the frequency band in which propagation is muted. This configuration enables little acoustic contamination along the apparatus 100. For example, the distance between the acoustic transmitters and receivers 404, 408 may be between 5 feet and about 10 feet.

The apparatus 100 may be configured with circumferentially spaced acoustic receivers that are coupled to a signal processor so that recordings may be made of signals detected by the receivers in synchronization with the firing of the signal source.

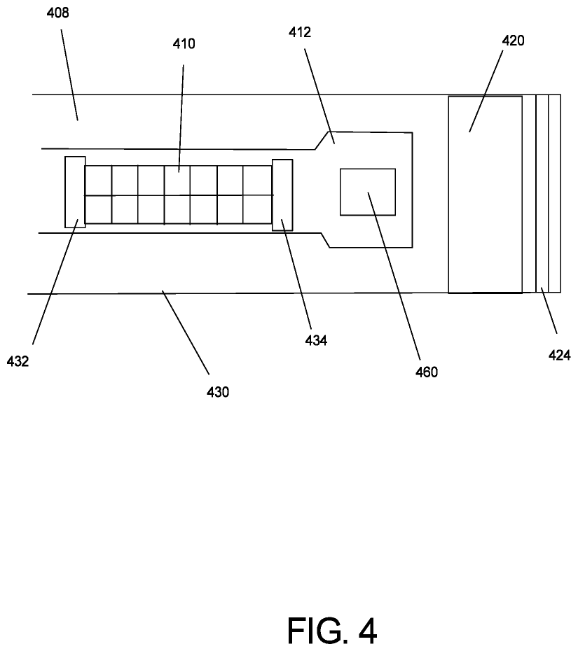

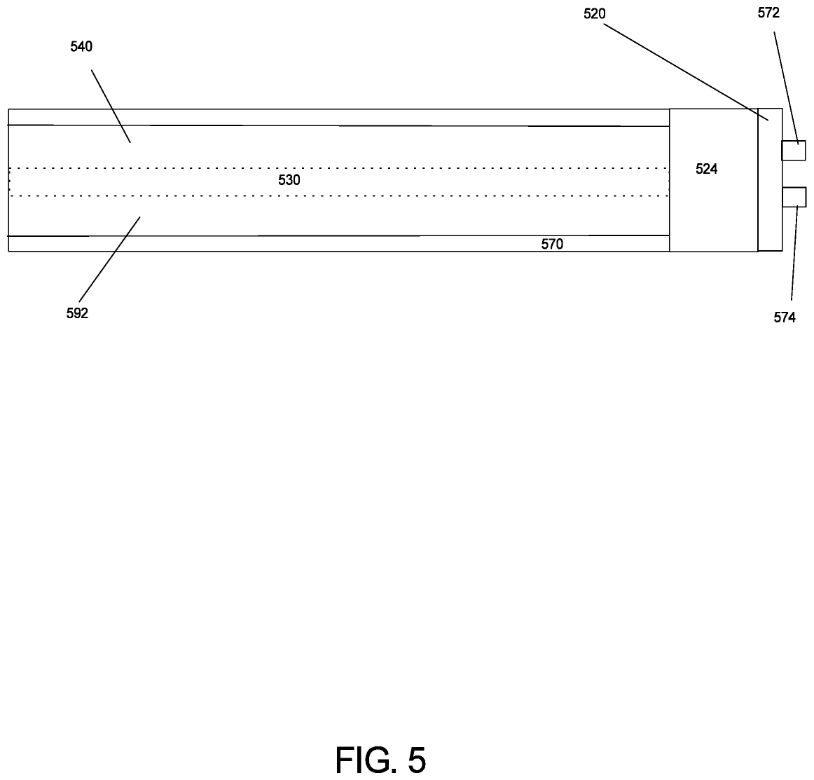

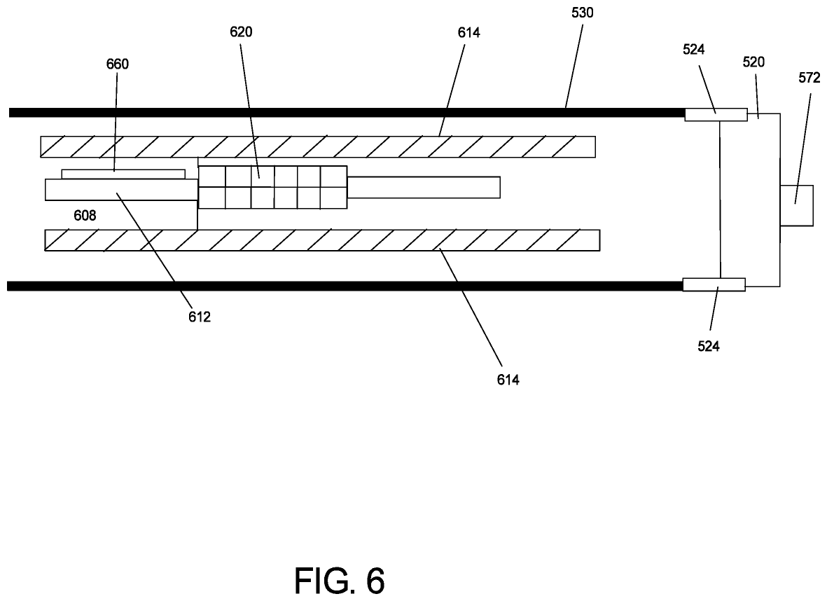

Multiple types of transducer assemblies are considered within the disclosure herein. A first transducer assembly is disclosed in conjunction with FIG. 4. A second alternative transducer assembly is also provided in FIGS. 5 and 6.

Referring to FIG. 4, a first transducer assembly for use in embodiments of the disclosure is illustrated. FIG. 4 shows a cross section of a portion of a transducer assembly, according to some embodiments. Transducer element 410 is mounted on a printed circuit board 412 using a fastening arrangement 432, 434. In some embodiments, the transducer element 410 used is only as an acoustic receiver and further electronics 460 are used for measuring, recording, processing and/or transmitting acoustic energy detected by the transducer element 410. These electronics 460 may interact with the cartridges, previously described, for storage of data and transfer of data to other tools and/or the uphole environment. In non-limiting embodiments, the transducer element 410 may comprise piezoelectric devices or other suitable devices known in the art.

Transducer element 410, electronics 460 and printed circuit board 412 are housed in a housing 430. In some embodiments, the housing 430 is made of rubber. The housing 430 may be a tube sealed at both ends. A silicone oil may be used to fill the tube.

Referring to FIG. 5, an alternative configuration of a transducer assembly according to one aspect of the disclosure. The transducer assembly is housed in a sealed container that includes a metal frame 530. The frame 530 is configured to expand and contract according to changes of volume of its contents. Bolts 572, 574 are positioned to allow an end cap 520 to be installed to a flange 524 at an end of the assembly.

Referring to FIG. 6, components along the frame 530 are shown in greater detail. A transducer element 620 is mounted on a printed circuit board 612. Electronics 660 are connected to the circuit board 612. As with the first embodiment, the electronics 660 are configured to interact with the cartridges, previously described, for storage and transfer of data to other tools and/or the uphole environment. An inner rubber holder 614 is positioned to hold connect the printed circuit board 612 to the frame 530. One or more cavities 608 are located to store silicone oil. Other embodiments may use electrically isolative fluids in the form of liquids, gases or gels.

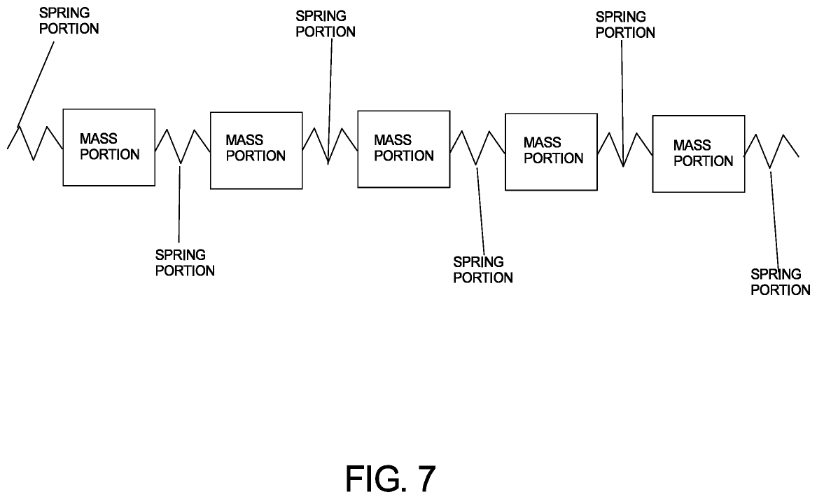

In alternative configurations, receiver sections for the apparatus 100 may have a number of receiver stations located along the length of the receiver section. In some embodiments, five different receiver sections may be provided. In a non-limiting embodiment, a mandrel may be provided to function as an acoustic mass and spring system. For modeling purposes, each of the receiver sections and connections between the receiver sections may be simulated by a mass portion and spring portion. Thus, in the case of a five receiver section, referring to FIG. 7, a five mass and spring model may be used. Configurations of an internal mandrel, therefore, may be used to limit the speed at which acoustic energy is transferred down the length of the apparatus. This speed delay may be used to prevent acoustic energy from reaching the receiver section and causing noise or inaccurate readings. The mandrel itself may be configured with grooves or complex shapes in order to provide necessary acoustic transfer capabilities to aid the receiver sections. In embodiments, protection of the apparatus 100 may be performed by a metal perforated sleeve to protect the acoustic receivers disposed therein. Each receiver station may include two pairs of wide band piezoelectric hydrophones aligned with dipole transmitters located in the source section. Different combinations of elements within the apparatus 100 may be used in different instances. For example, when a dipole transmitter is fired in the source section, a hydrophone pair located diagonally in line with the dipole transmitter may be used.

In some embodiments, the structures for holding the components described above may act as a mechanical band-stop filter wherein the band may be determined according to the diameter of the apparatus 100 and the periodicity in the axial direction.

Differing arrangements of the source section may be used. The source section may include a piezoelectric monopole transmitter and two electrodynamic dipole transmitters perpendicular to each other. To excite compressional and shear waves, an electric pulse at frequencies may be applied to the monopole transmitter.

In one example embodiment, an acoustic apparatus is described. The apparatus may comprise an acoustic source section, at least two acoustic receiver sections, an isolator section arranged between the acoustic source section and the at least two acoustic receiver sections, wherein the isolator section is configured to function acoustically as a tuned mechanical band-stop filter. The apparatus may also be configured wherein each acoustic receiver section has at least one sensor, at least one amplifier, an analog-to-digital converter and multiplexer in one module.

In another embodiment, the acoustic apparatus may be configured wherein the acoustic source section is configured to perform at least one of monopole, cross-dipole and acoustic reflection surveys.

In another embodiment, the acoustic apparatus may be configured wherein the at least two acoustic receiver sections are configured to receive monopole, cross-dipole and acoustic reflection surveys.

In another embodiment, the acoustic apparatus may be configured wherein each of the at least two acoustic receiver sections has a perforated sleeve around an exterior of the section.

In another embodiment, the acoustic apparatus may be configured wherein a structure of the apparatus has an extensional mode that is muted.

In another embodiment, the acoustic apparatus may be configured wherein a structure of the apparatus has a flexural mode that is muted.

In another embodiment, the acoustic apparatus may be configured wherein the acoustic source section is configured to perform monopole and cross-dipole surveys.

In another embodiment, the acoustic apparatus may be configured wherein the acoustic source section is further configured to perform acoustic reflection surveys.

In another embodiment, the acoustic may be configured wherein the acoustic source section is configured to perform the monopole, cross-dipole and acoustic reflection surveys at one time.

In another embodiment, an acoustic apparatus is disclosed. The acoustic apparatus may comprise an acoustic source section, at least one acoustic receiver section and an isolator section arranged between the acoustic source section and the acoustic receiver section, wherein the isolator section is configured to function acoustically as a tuned mechanical band-stop filter, and wherein the isolator section is configured to mute sonic signal propagation along the apparatus for which formation signals are considered to be dominant. The apparatus may also be configured to wherein each acoustic receiver section comprises: a transducer element configured to detect acoustic signals; an electronic circuit configured to process the acoustic signals, the electronic circuit including an amplifier, and an analog-to-digital converter; and a digital multiplexer. The acoustic receiver section may also comprise a fluid container configured to house the transducer element and the electronic circuit, and wherein the sensors, the amplifier and the analog-to-digital converter are placed in an individual module and the electronic circuit is configured to simultaneously conduct monopole and dipole sonic logging and acoustic reflection surveys.

In another example embodiment, the acoustic apparatus may be configured wherein the acoustic source section comprises both a monopole acoustic source and a dipole acoustic source.

In another example embodiment, the acoustic apparatus may further comprise a perforated sleeve arranged around the acoustic receiver section.

In another example embodiment, the acoustic apparatus may be configured wherein the acoustic receiver section comprises an acoustic transducer element, an elongated fluid filled sealed container housing the transducer element, wherein the container housing further comprises at least one flexible portion along a length of the container housing for volume changes, a tubular member having two open ends, and two end caps closing the two open ends.

In another example embodiment, the acoustic apparatus may be configured wherein the container housing is filled with a non-conductive fluid.

In another embodiment, an acoustic apparatus is disclosed. The apparatus may comprise an acoustic source section, an acoustic receiver section and an isolator section arranged between the acoustic source section and the acoustic receiver section, wherein the isolator section is configured to function acoustically as a tuned mechanical band-stop filter, and wherein the isolator section is configured to mute sonic signal propagation along the apparatus for which formation signals are considered to be dominant. Each acoustic receiver section may comprise a transducer element configured to detect acoustic signals, an electronic circuit configured to process the acoustic signals, the electronic circuit including an amplifier, and an analog-to-digital converter, and a digital multiplexer. The acoustic apparatus may further comprise a fluid container configured to house the transducer element and the electronic circuit. The acoustic apparatus may also be configured wherein the sensors, the amplifier, and the analog-to-digital converter are placed in an individual module; and wherein the acoustic apparatus is configured to be one of attached to a drill string and placed on a wireline, and the electronic circuit is configured to simultaneously conduct monopole and dipole sonic logging and acoustic reflection surveys.

In another example embodiment, the acoustic apparatus may further comprise a perforated sleeve arranged around the acoustic receiver section.

In another example embodiment, the acoustic apparatus may be configured wherein the apparatus is further configured to be conveyed through a drill string.

In another example embodiment, the acoustic apparatus may be configured wherein the apparatus is further configured to be conveyed through a drill bit located at a bottom of the drill string.

In another example embodiment, the acoustic apparatus may be configured wherein the apparatus is tethered.

In another example embodiment, the acoustic apparatus may be configured wherein the apparatus is untethered.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. An acoustic apparatus, comprising:
an acoustic source section;
at least two acoustic receiver sections;
an isolator section arranged between the acoustic source section and the at least two acoustic receiver sections, wherein the isolator section is configured to function acoustically as a tuned mechanical band-stop filter; and
wherein each acoustic receiver section has at least one sensor, at least one amplifier, an analog-to-digital converter and multiplexer in one module.

2. The acoustic apparatus according to claim 1, wherein the acoustic source section is configured to perform at least one of monopole, cross-dipole and acoustic reflection surveys.

3. The acoustic apparatus according to claim 1, wherein the at least two acoustic receiver sections are configured to receive monopole, cross-dipole and acoustic reflection surveys.

4. The acoustic apparatus according to claim 1, wherein each of the at least two acoustic receiver sections has a perforated sleeve around an exterior of the section.

5. The acoustic apparatus according to claim 1, wherein a structure of the apparatus has an extensional mode that is muted.

6. The acoustic apparatus according to claim 1, wherein a structure of the apparatus has a flexural mode that is muted.

7. The acoustic apparatus according to claim 1, wherein the acoustic source section is configured to perform monopole and cross-dipole surveys.

8. The acoustic apparatus according to claim 7, wherein the acoustic source section is further configured to perform acoustic reflection surveys.

9. The acoustic apparatus according to claim 8, wherein the acoustic source section is configured to perform the monopole, cross-dipole and acoustic reflection surveys at one time.

10. An acoustic apparatus, comprising:
an acoustic source section;
at least one acoustic receiver section;
an isolator section arranged between the acoustic source section and the acoustic receiver section, wherein the isolator section is configured to function acoustically as a tuned mechanical band-stop filter, and wherein the isolator section is configured to mute sonic signal propagation along the apparatus for which formation signals are considered to be dominant; and
wherein each acoustic receiver section comprises:
a transducer element configured to detect acoustic signals;
an electronic circuit configured to process the acoustic signals, the electronic circuit including an amplifier, and an analog-to-digital converter;
a digital multiplexer; and
a fluid container configured to house the transducer element and the electronic circuit, and wherein the sensors, the amplifier and the analog to analog-to-digital converter are placed in an individual module and the electronic circuit is configured to simultaneously conduct monopole and dipole sonic logging and acoustic reflection surveys.

11. The acoustic apparatus according to claim 10, wherein the acoustic source section comprises both a monopole acoustic source and a dipole acoustic source.

12. The acoustic apparatus according to claim 10, further comprising:
a perforated sleeve arranged around the acoustic receiver section.

13. The acoustic apparatus according to claim 10, wherein the acoustic receiver section comprises:
an acoustic transducer element;
an elongated fluid filled sealed container housing the transducer element, wherein the container housing further comprises at least one flexible portion along a length of the container housing for volume changes; and
a tubular member having two open ends; and
two end caps closing the two open ends.

14. The acoustic apparatus according to claim 10, wherein the container housing is filled with a non-conductive fluid.

15. An acoustic apparatus, comprising:
an acoustic source section;
an acoustic receiver section;
an isolator section arranged between the acoustic source section and the acoustic receiver section, wherein the isolator section is configured to function acoustically as a tuned mechanical band-stop filter and wherein the isolator section is configured to mute sonic signal propagation along the apparatus for which formation signals are considered to be dominant; and
wherein each acoustic receiver section comprises
a transducer element configured to detect acoustic signals;
an electronic circuit configured to process the acoustic signals, the electronic circuit including an amplifier, and an analog-to-digital converter;
a digital multiplexer; and
a fluid container configured to house the transducer element and the electronic circuit,
and wherein the sensors, the amplifier and the analog-to-digital converter are placed in an individual module; and wherein the acoustic apparatus is configured to be one of attached to a drill string and placed on a wireline and the electronic circuit is configured to simultaneously conduct monopole and dipole sonic logging and acoustic reflection surveys.

16. The acoustic apparatus according to claim 15, further comprising:
a perforated sleeve arranged around the acoustic receiver section.

17. The acoustic apparatus according to claim 15, wherein the apparatus is further configured to be conveyed through a drill string.

18. The acoustic apparatus according to claim 17, wherein the apparatus is further configured to be conveyed through a drill bit located at a bottom of the drill string.

19. The acoustic apparatus according to claim 16, wherein the apparatus is tethered.

20. The acoustic apparatus according to claim 16, wherein the apparatus is untethered.
